(19) United States
(12) Patent Application Publication
(10) Pub. No.: US 2017/0064361 A1
(43) Pub. Date: Mar. 2, 2017

(54) ONLINE STREAMING MEDIA DEVICE/SET-TOP BOX WITH BUILT-IN DIGITAL TELEVISION TUNER

(71) Applicant: MODTECH GLOBAL, NEWPORT BEACH, CA (US)

(72) Inventors: EPIFANIO T. PINCA, IV, NEWORT BEACH, CA (US); EPIFANIO T. PINCA, V, NEWPORT BEACH, CA (US)

(73) Assignee: MODTECH GLOBAL, NEWPORT BEACH, CA (US)

(21) Appl. No.: 15/019,092

(22) Filed: Feb. 9, 2016

Related U.S. Application Data
(60) Provisional application No. 62/210,796, filed on Aug. 27, 2015.

(51) Int. Cl. H04N 21/2665; H04N 21/431; H04N 21/643; H04N 21/482; H04N 21/426

(52) U.S. Cl. CPC H04N 21/2665; H04N 21/4821; H04N 21/4263; H04N 21/64322; H04N 21/4312

(57) ABSTRACT

A set-top box for controlling a display device includes a controller, a first circuitry for receiving over-the-air broadcast digital content, a second circuitry for receiving online streaming content over IP protocol, and an operating system running on the controller. The operating system is configured to allow a user to selectively switch between on-line content and local over-the-air broadcast programs without shutting down the set-top box.

### CROSS-REFERENCE TO RELATED APPLICATIONS

The present application claims priority to, and the benefit of, U.S. Provisional Patent Application Ser. No. 62/210,796, entitled “ALL-IN-ONE ONLINE STREAMING MEDIA DEVICE/SET-TOP-BOX WITH BUILT-IN MODULAR HD-TV TUNER,” filed on Aug. 27, 2015, the disclosure of which is herein incorporated by reference in its entirety.

### STATEMENT RE: FEDERALLY SPONSORED RESEARCH/DEVELOPMENT

Not Applicable

### BACKGROUND

Technical Field

The present disclosure relates generally to the field of electronic communications. More particularly, the present disclosure relates to an online streaming media device/set-top box with a built-in digital television (DTV) tuner.

Discussion of Related Art

Many consumers utilize electronic devices to be able receive a range of electronic entertainment, including television shows, movies, music and other content. The global networking infrastructure, including the Internet, along with the capabilities of ubiquitous, always-on smart televisions and mobile devices, means that consumers are seldom far from their favorite websites, television shows and movies. For example, Internet protocol television (IPTV) provides traditional television stations (live channels) to subscribers from Internet service providers, and video-on-demand (VoD) provides stored content (e.g., movies, episodes, etc.) over the Internet protocol (IP). As access points and devices proliferate, and as consumers demand more personalized products and even greater control, limited device capabilities may adversely impact distribution opportunities and consumer experiences.

Media and entertainment consumption and consumer expectations have shifted significantly in recent years. Over-the-air (OTA) television has moved from analog transmission to digital. It is becoming increasingly prevalent for content service providers, such as television broadcasters, cable television companies, and the like, to provide services including television channel lineup over the IP network, as opposed to OTA broadcast, cable, telecommunications, satellite, or DVD/Blu-ray disc based delivery. Over-the-top (OTT) has become a general term referring to the on-line delivery of audio, video, images, and other media without the involvement of an Internet service provider (ISP) in the control or distribution of the content. The ISP may be aware of the contents of the IP packets associated with the OTT content, but may not be responsible for, or able to control, the viewing abilities, copyrights, and/or other redistribution of the content. This is in contrast to delivery based on purchase or rental of video or audio content from the ISP, such as VoD over IP or an IPTV video service, e.g., AT&T U-Verse. OTT refers to content that arrives from commercial content providers, such as Amazon Instant Video, Apple iTunes, CBS All Access, Crunchyroll, Epix, Fox Sports Go, Google Play, HBO Go, HBO Now, Hulu Plus, M-GO, MLB.TV, MLS Live, NBA League Pass, Netflix, NFL Now, NHL Game Center Live, Plex, Showtime Anytime, Sling TV, Sony Video Unlimited, Sony PlayStation Vue, Twitch, Vudu, WatchESPN, WWE Network, Xbox Video, and YouTube, and is delivered to an end-user device, leaving the ISP only the role of transporting IP packets. For telecom, cable, media and content businesses, OTT subscriptions represent a new business model.

Digital signals are routinely transmitted using terrestrial methods. The transmission method has different names in different parts of the world. For example, the term “DVB-T” is used in Europe and Australia. North American customers receive these signals using a set of standards approved by the Advanced Television Systems Committee (ATSC). High-definition (HD) broadcast video content is typically delivered to the home via an electronic device commonly referred to as a set-top box (STB) that includes circuitry for processing television signals into content displayable on a television. In general, STBs are processing devices that receive television signals from an external signal source, and then use a tuner or other mechanism to convert the television signals into audio-visual content, which can be displayed on a television. STBs typically respond to user input, such as from a remote control device, to change channels, modify display configuration, etc. STBs may be connected to a home network through built-in Ethernet, Wi-Fi, or multimedia over coax alliance (MoCA) interface, etc. To provide a high-quality viewing experience, the STB and the display device, e.g., an HD television (HDTV), may be connected by a high-definition multimedia interface (HDMI) link, which supports standard, enhanced, or high-definition video, plus multi-channel digital audio on a single cable. In general, broadcasting television directly to devices other than STBs is difficult because most consumer electronic devices do not provide built-in television tuners.

There is a need for innovation in consumer electronic devices to offer a variety of content to enhance the user experience.

### BRIEF SUMMARY

According to an aspect of the present disclosure, a set-top box for controlling a display device is provided. The set-top box includes a first circuitry for receiving over-the-air broadcast digital content and a second circuitry for receiving online streaming content over IP protocol. The set-top box includes an operating system running on the controller. The operating system is configured to allow a user to selectively switch between on-line content and local over-the-air broadcast programs without shutting down the set-top box.

According to another aspect of the present disclosure, a method of distributing content to a display device is provided. The method includes receiving, by a set-top box, over-the-air broadcast television content via a first antenna and receiving, by the set-top box, online streaming content over IP protocol via a second antenna. The method also includes partitioning a display area of a display device into a first region and a second region, and displaying television content in the first region while simultaneously displaying online streaming content in the second region.

### BRIEF DESCRIPTION OF THE DRAWINGS

Objects and features of the presently-disclosed online streaming media device/set-top box with a built-in digital television (DTV) tuner will become apparent to those of ordinary skill in the art when descriptions of various embodiments thereof are read with reference to the accompanying drawings, of which:

FIG. 1 is a perspective view of a content delivery system including an online streaming media device/set-top box in accordance with an embodiment of the present disclosure;

FIG. 2 is a diagrammatic representation of a content delivery system including a conventional media system for delivering over-the-top (OTT) content;

FIG. 3 is a perspective view of a system architecture for an online streaming media device/set-top box including an operating system in accordance with an embodiment of the present disclosure;

FIG. 4 is a perspective front-top view of the online streaming media device/set-top box of the system of FIG. 1 in accordance with an embodiment of the present disclosure;

FIG. 5 is a perspective back-top view of the set-top box device of the system of FIG. 1 in accordance with an embodiment of the present disclosure.

FIG. 6 is a perspective front-top view of another embodiment of an online streaming media device/set-top box in accordance with an embodiment of the present disclosure; and

FIG. 7 is a perspective back-top view of the online streaming media device/set-top box of FIG. 6 in accordance with an embodiment of the present disclosure.

### DETAILED DESCRIPTION

Hereinafter, embodiments of an online streaming media device/set-top box with a built-in digital television (DTV) tuner are described with reference to the accompanying drawings. Like reference numerals may refer to similar or identical elements throughout the description of the figures.

This description may use the phrases “in an embodiment,” “in embodiments,” “in some embodiments,” or “in other embodiments,” which may each refer to one or more of the same or different embodiments in accordance with the present disclosure.

As used herein, the term “power source” refers to any source of electrical power, e.g., electrical outlet, a/c generator, battery or battery pack, etc. As it is used in this description, “transmission line” generally refers to any transmission medium that can be used for the propagation of signals from one point to another. A transmission line may be, for example, a wire, two or more conductors separated by an insulating medium (two-wire, coaxial, microstrip, etc.), a waveguide, a fiber optic line and/or fiber optic bundles. As it is used in this description, “switch” or “switches” generally refers to any electrical actuators, mechanical actuators, electro-mechanical actuators (rotatable actuators, pivotable actuators, toggle-like actuators, buttons, etc.), optical actuators, or any suitable device that generally fulfills the purpose of connecting and disconnecting electronic devices, or component thereof, instruments, equipment, transmission line or connections, or software.

As it is used in this description, “printed circuit board” (or “PCB”) generally refers to systems that provide, among other things, mechanical support to electrical devices and/or components, electrical connection to and between these electrical components, combinations thereof, and the like. The PCBs described herein are not limited to electrical component-populated boards, but also include non-populated circuit traced substrates of all types, e.g., semiconductor integrated circuits, etc. As it is used in this description, “light-emitting element” generally refers to any light source that is capable of receiving an electrical signal and producing a color of light in response to the signal. Examples of a light-emitting elements include light-emitting diodes (LEDs) and other opto-semiconductor devices.

As it is used herein, the term “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). In this description, the terms “software” and “code” may be applicable to software, firmware, or a combination of software and firmware. Examples of software may include: software; code segments; instructions; applets; pre-compiled code; compiled code; interpreted code; computer programs; and programmed logic. For the purposes of this description, “non-transitory” computer-readable media includes all computer-readable media, with the sole exception being a transitory, propagating signal. The “computer-readable media” can be an electronic, magnetic, optical, electromagnetic, infrared, or semiconductor system (or apparatus or device). Examples of computer-readable media include: a semiconductor or solid state memory; magnetic media such as hard disks, floppy disks, and magnetic tape; a removable computer diskette; optical media such as a compact disk with read only memory (CD-ROM), a compact disk with read/write (CD-R/W), a digital video disk (DVD), and holographic devices; magneto-optical media; and hardware devices that are specially configured to store and execute program code, such as application-specific integrated circuits (ASICs), programmable logic devices (PLDs) and read-only memory (ROM) and random access memory (RAM) devices. Examples of computer code include machine code, such as produced by a compiler, and files containing higher-level code that are executed by a computer using an interpreter. As it is used herein, the term “controller” may include any type of computing device, computational circuit, or any type of processor or processing circuit capable of executing a series of instructions that are stored in a memory associated with the controller.

Various embodiments of the present disclosure provide a system and method for selecting content through an online streaming media device/set-top box with a built-in HDTV tuner. Embodiments of the presently-disclosed online streaming media device/set-top box may be suitable for use with a variety of display devices, such as televisions, monitors, or other devices configured to display video images and provide an audio output. The presently-disclosed online streaming media device/set-top box provides an economical and convenient way to allow the user simultaneous access to on-line content and local over-the-air (OTA) broadcast programs. During operation of the presently-disclosed online streaming media device/set-top box, on-line content and local OTA broadcast programs may be displayed simultaneously on a display device (e.g., the display area may be partitioned into multiple regions) based on user selection, or the user may selectively switch between on-line content and local OTA broadcast programs without shutting down the online streaming media device/set-top box. Embodiments of the presently-disclosed online streaming media device/set-top box may provide the capability to organize on-line content and local OTA broadcast programs to provide users with more personalized products and even greater control.

As will be appreciated by those of ordinary skill in the art, embodiments of at least portions of presently-disclosed online streaming media device/set-top box may be embodied as a method, a data processing system, a device for data processing, and/or a computer program product. Accordingly, the present disclosure may take the form of an entirely software embodiment, an entirely hardware embodiment, or an embodiment combining aspects of both software and hardware. Furthermore, the present disclosure may take the form of a computer program product on a computer-readable storage medium having computer-readable program code embodied in the storage medium.

The presently-disclosed online streaming media device/set-top box embodiments may be described herein in terms of functional block components. It should be appreciated that such functional blocks may be realized by any number of hardware and/or software components configured to perform the specified functions. For example, the present disclosure may employ various integrated circuit components, e.g., memory elements, processing elements, logic elements, look-up tables, and the like, which may carry out a variety of functions under the control of one or more controllers, processors and/or other control devices.

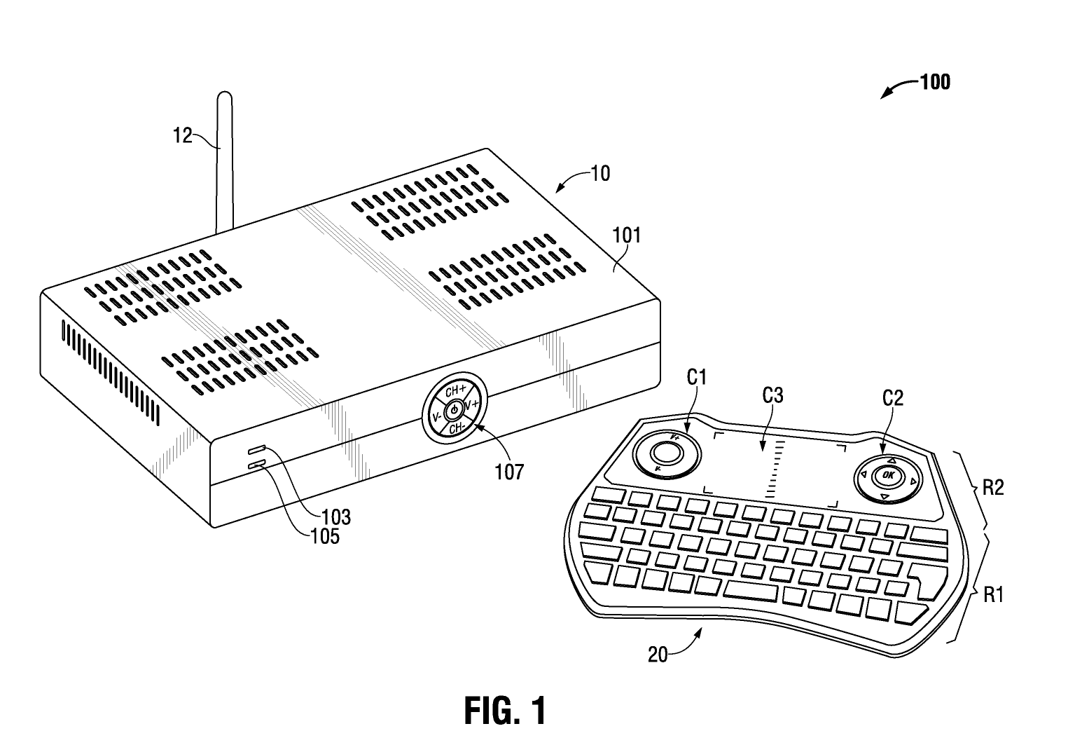

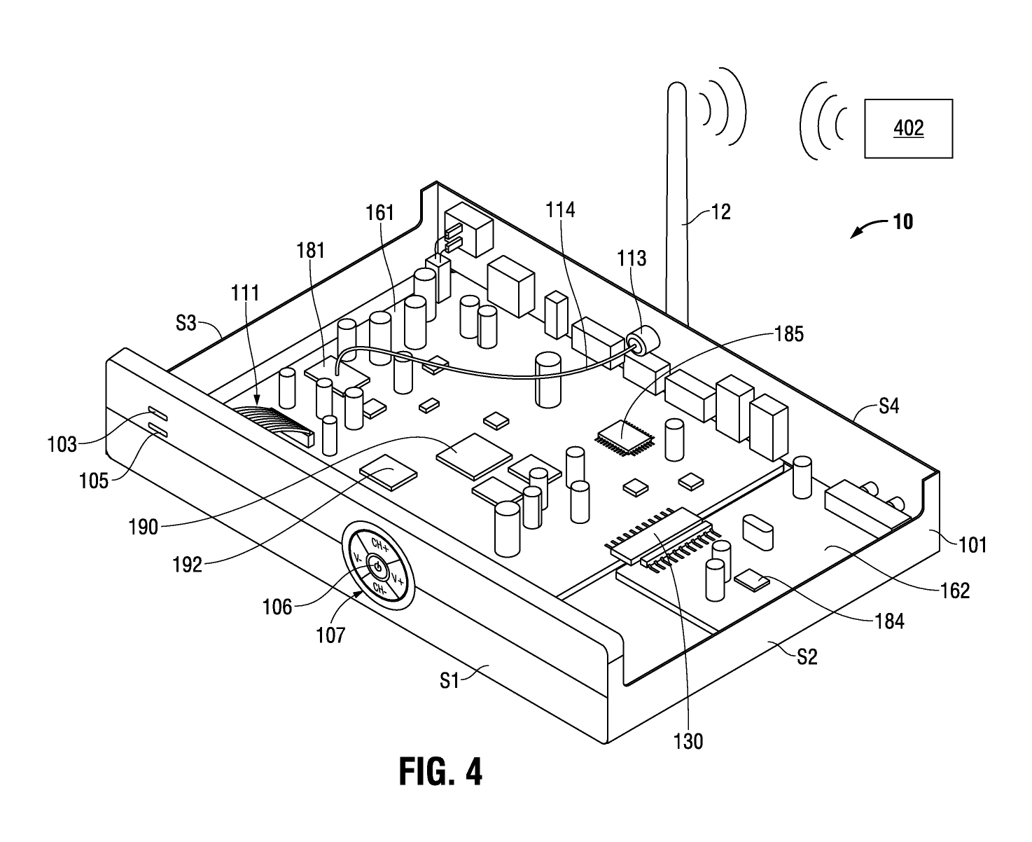

FIG. 1 shows a content delivery system 100 for the delivery of television program and online streaming media in accordance with an embodiment of the present disclosure that includes an online streaming media device/set-top box 10 (also referred to simply as “set-top box 10”) and a remote control device 20. The remote control device 20 may employ wired or wireless connections to send commands to the set-top box 10 to allow a user to provide menu navigation, text input, and control. As shown in FIG. 1, the set-top box 10 includes an antenna 12. Antenna 12 may be utilized for receiving signals from a wireless signal antenna of a router 402 (shown in FIG. 4). Antenna 12 may be configured to provide two-way communication with an IP network.

Set-top box 10 generally includes a housing 101 that may be configured to contain various components of the set-top-box 10. As shown in FIGS. 1 and 4, a first visual indicator device 103, a second visual indicator device 105, and a user input device 107 are coupled to the housing 101. It is to be understood that any configuration of features, e.g., externally-visible visual indicator devices, audio indicator devices, pushbuttons, switches, microphones, image capture devices, and/or other sensors, may be coupled to or otherwise associated with the housing 101. Those skilled in the art will recognize that the location of the first visual indicator device 103, the second visual indicator device 105, and the user input device 107 may be varied from the configuration depicted in FIGS. 1 and 4.

The first visual indicator device 103 and the second visual indicator device 105 may employ any suitable light-emitting elements, e.g., light-emitting diodes (LEDs). In the embodiment illustrated in FIG. 1, the first visual indicator device 103 is a power on/off indicator light, and the second visual indicator device 105 is a remote control signal indicator light. In some embodiments, the user input device 107 is centrally located on side S1 of the housing 101 and includes a volume increase button (e.g., indicated by “V+”), a volume decrease button (e.g., indicated by “V−”), a channel increment button (e.g., indicated by “CH+”), a channel decrement button (e.g., indicated by “CH−”), and a sleep/awake button 106 for providing the user with a capability to suspend/resume operations of the set-top box 10.

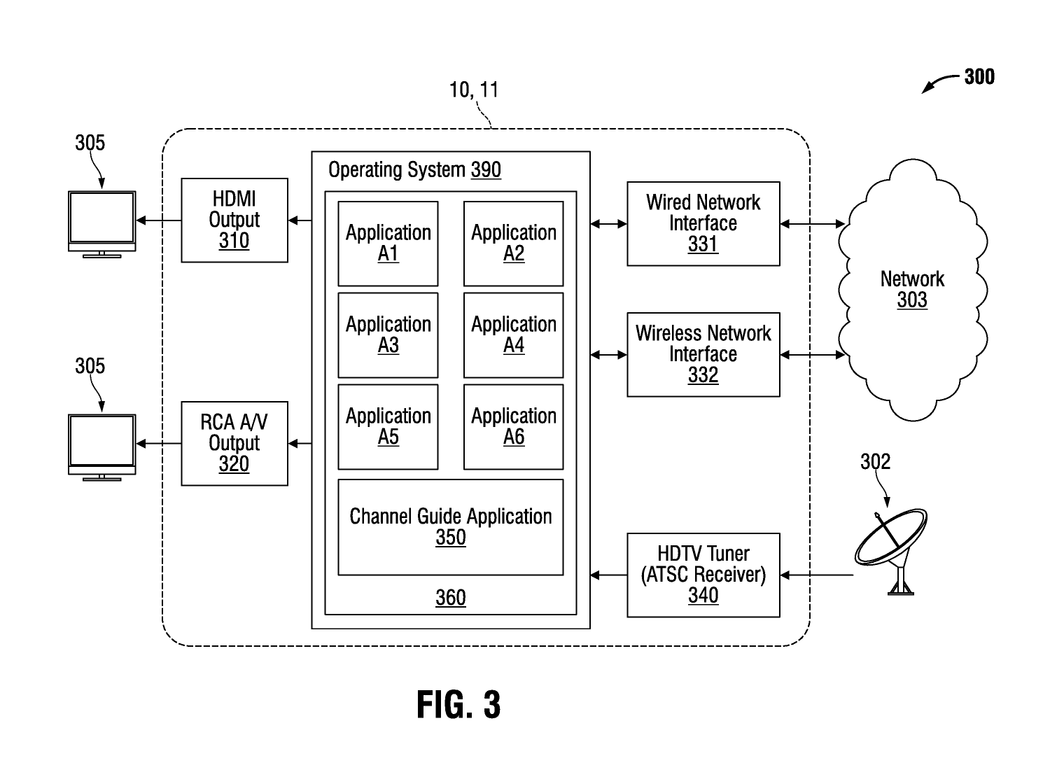

A user may control the set-top box 10 to display content on a display device 305 (shown in FIG. 3). In some embodiments, the set-top box 10 may be configured to partition the display area of the display device for the content that may be user selected from on-line content and local OTA broadcast channels to enhance the user experience. For example, the display area may be partitioned into two regions of the same or different size, or partitioned into a four-quadrant configuration. Other suitable configurations of two or more regions may be utilized. During operation of the set-top box 10, on-line content and local OTA broadcast programs may be displayed simultaneously on the display device 305. In some embodiments, the set-top box 10 may be configured to allow the user to select and/or modify the size, shape and/or number of viewing regions presented on the display device 305. The content may include data, files, information, instructions, video, music, advertisements, websites, links, or other distributable content. In some embodiments, the set-top box 10 may be configured to connect with computing and/or communications devices (e.g., laptops, tablets, Ultrabooks, smart phones, etc.) or other wireless devices. The set-top box 10 may send and receive content and signals according to one or more formats, standards or protocols, e.g., Wi-Fi, Bluetooth, etc. In one embodiment, browsers or applications of the wireless devices may be utilized to retrieve content through the set-top box 10. For example, a mobile application may allow the wireless devices to interact with the set-top box 10.

In some embodiments, the set-top box 10 may be controlled using the remote control device 20 that may be wired or wireless. Remote control device 20 communicates with set-top box 10 (e.g., by transmitting a signal) in response to receiving input from the user. Set-top box 10 may also transmit a signal to the remote control device 20. In some embodiments, the remote control device 20 communicates wirelessly with the set-top box 10 using one or more optical (e.g., infrared) and/or radio frequency (e.g., 802.11) communications protocols. In other embodiments, the remote control device 20 may be physically integrated with the set-top box 10.

As shown in FIG. 1, the wireless remote control device 20 has an ergonomic design that generally includes a first region R1, e.g., a region proximate the user, and a second region R2. The first region R1 includes a keyboard. The keyboard generally includes backlit keys. Some embodiments may include controllers within the keyboard that are capable of dynamically programming illumination for the keys based upon interaction from the user. In the embodiment illustrated in FIG. 1, the second region R2 includes a first control device C1, a second control device C2, and a third control device C3. The first control device C1 may be a volume control button with a capability to increase volume (e.g., indicated by “V+”) and with a capability to decrease volume (e.g., indicated by “V−”). The second control device C2 may be a touch pad. In other embodiments, the second control device C2 may be a trackball or other device. The third control device C3 may be a scroll button with a capability for horizontal and vertical scrolling (e.g., indicated by arrows). The remote control device 20 may include an earphone jack.

It is to be understood that the remote control device 20 of the present disclosure may utilize many different configurations of devices, e.g., input and output devices, some with additional, fewer, or different input devices than depicted in FIG. 1. For example, the remote control device 20 may include various buttons, trackballs, accelerometers, motion and/or position sensors and circuitry, feedback/actuation components, voice or handwriting recognizers, biometrics readers, a touchscreen, a Braille interface, speakers, a microphone, and/or other similar input and output devices as needed to provide for an interface between a user and the set-top box 10.

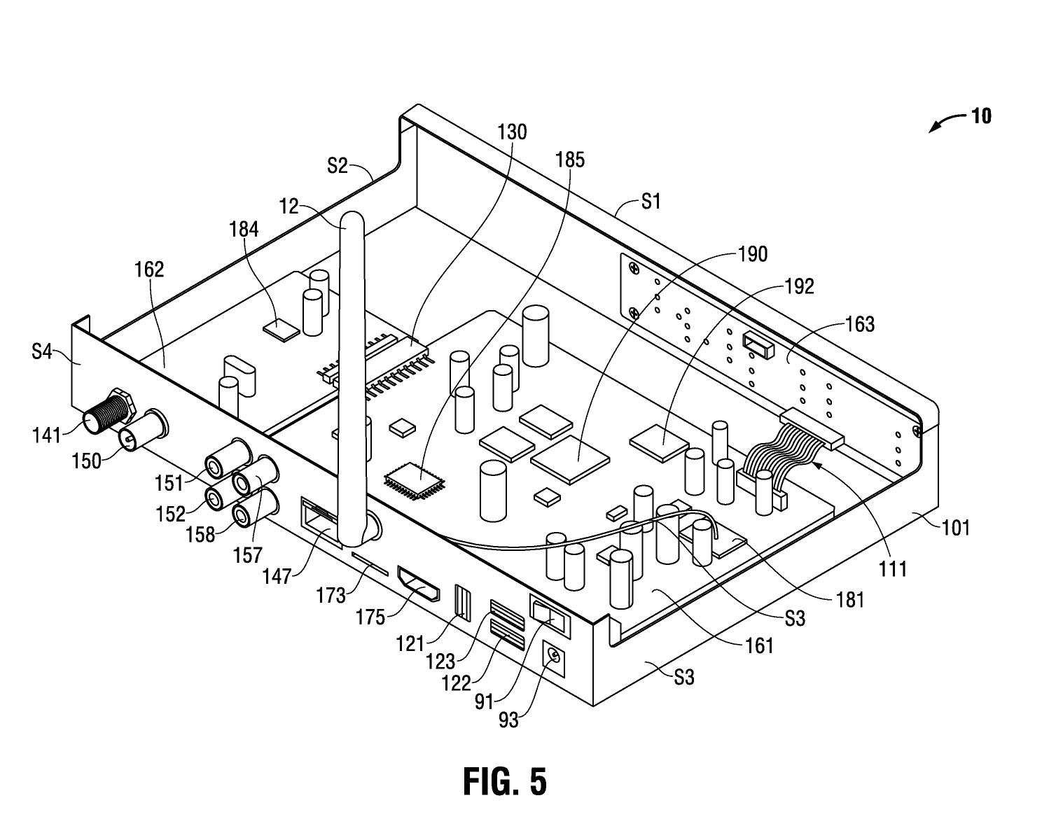

The housing 101 may have a rectangular shape or any other suitable shape. As shown in FIGS. 4 and 5, the housing 101 includes four sides S1, S2, S3 and S4. The housing 101 may be formed of plastic, ceramics, composites, metal (e.g., stainless steel, aluminum, etc.), other suitable materials, or a combination of materials. The housing 101 may be formed using a unibody configuration in which some or all of the housing 101 is machined, molded, or otherwise formed as a single structure, or may be formed using multiple structures, e.g., an internal frame structure, one or more structures that form exterior housing surfaces, etc. In some embodiments, the housing 101 includes a first portion (e.g., top cover) that is releasably and removably attachable to a second portion (e.g., base).

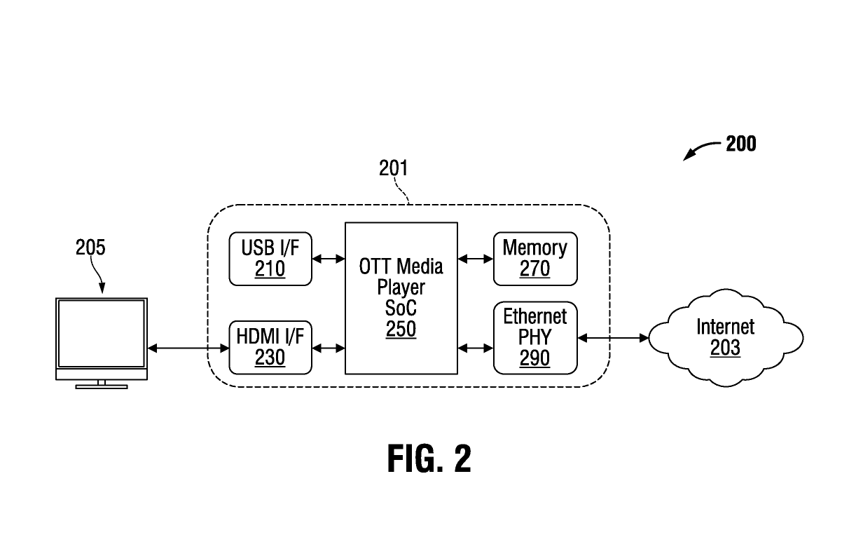

In FIG. 2, a content delivery system 200 is shown that includes a display device 205 and a conventional media system 201 for delivering over-the-top (OTT) content. As shown in FIG. 2, the media system 201 includes an OTT media player system on chip (SoC) 250, a memory device 270, a universal serial bus (USB) interface 210, and a high-definition multimedia interface (HDMI) interface 230. Content from the Internet 203 may be conducted by the Ethernet physical layer (PHY) 290 to the media player 201. Content from the media system 201 may be output via the HDMI interface 230 to the display device 205. Content from the media system 201 may be output via the USB interface 210 to an external hard drive or other storage device.

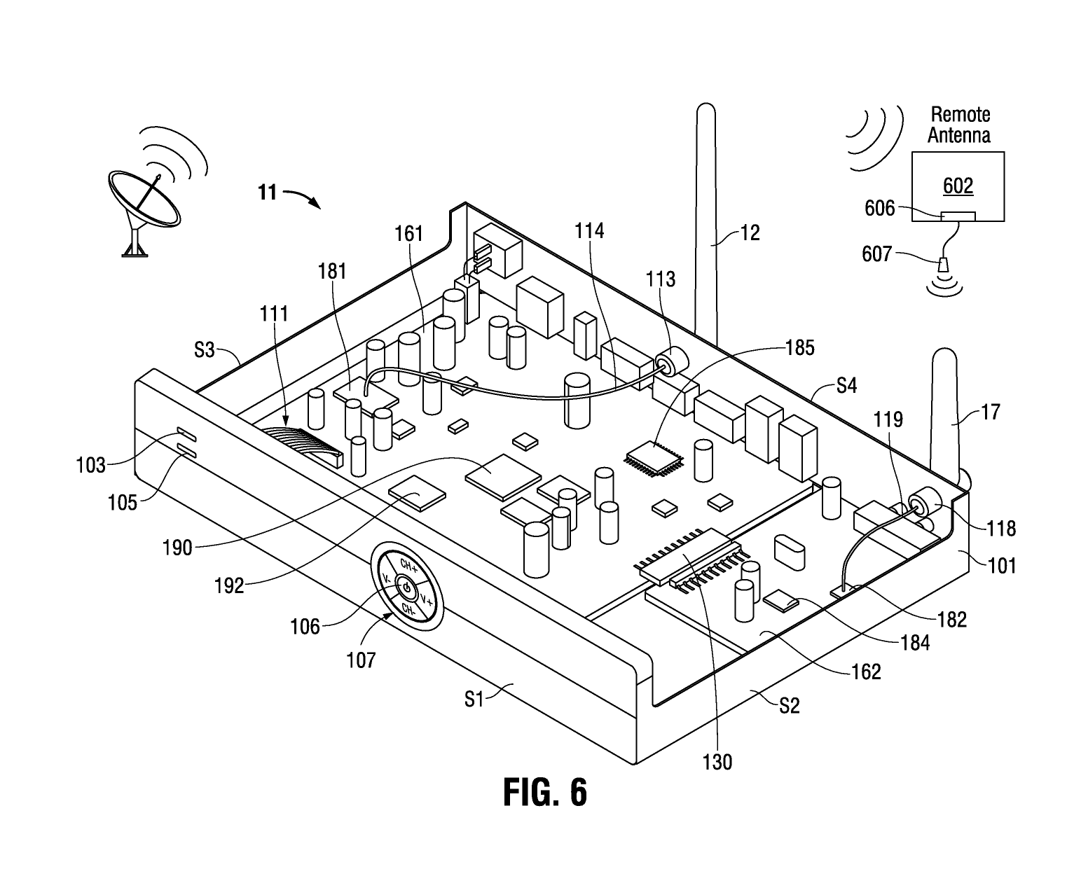

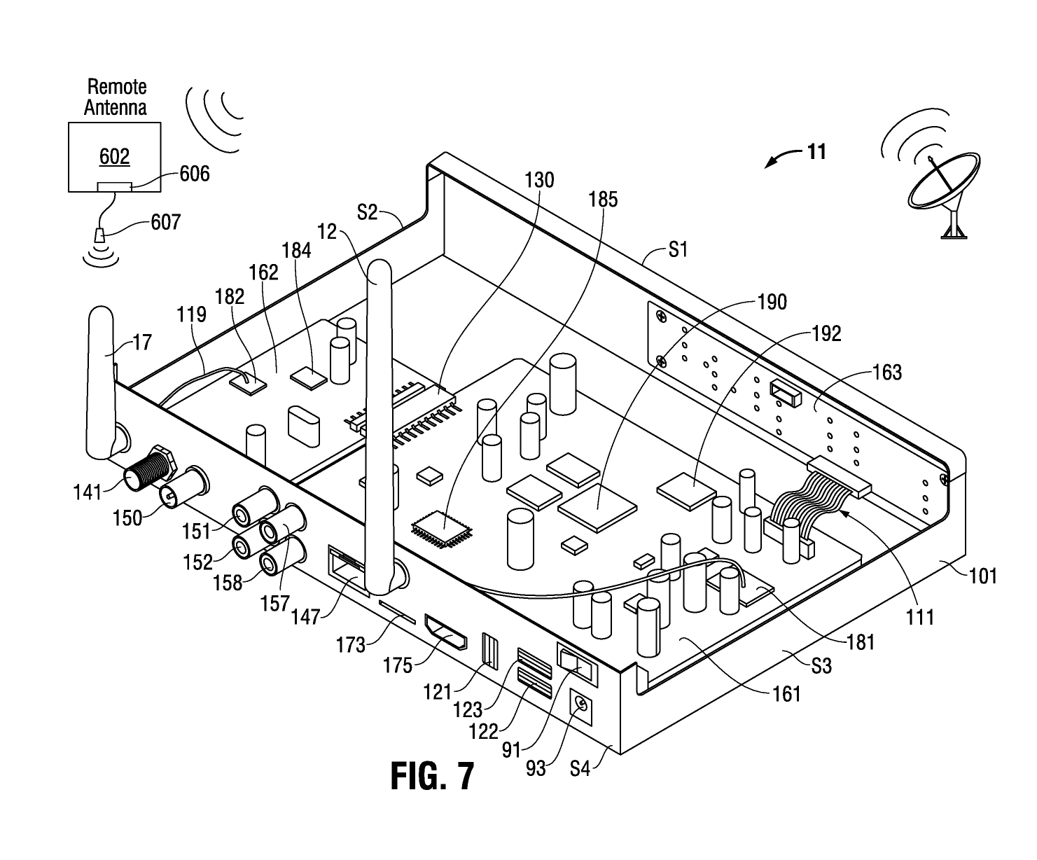

FIG. 3 shows a system architecture 300 for an online streaming media device/set-top box (e.g., set-top box 10 shown in FIGS. 1, 3 and 4, and set-top box 11 shown in FIGS. 6 and 7) in accordance with an embodiment of the present disclosure. The set-top box 10, 11 includes a computer-readable medium 192 (shown in FIGS. 4-7), which may be used to store at least a portion of one or more items of content for display on a display device 305.

As shown in FIG. 3, the set-top box 10, 11 includes an operating system 390. In some embodiments, the operating system 390 may be an open source operating system (e.g., Linux, Android OS, Firefox OS, etc.) or a proprietary operating system (e.g., Windows, Mac OS, etc.). The software instructions, which are executable by the controller 190, are stored in the computer-readable medium 192. The various processes and functions described herein may be part of an application program (e.g., application A1, A2, A3, A4, A5, A6, or combination thereof, as described below) which is executed via the operating system 390.

Set-top box 10, 11 includes a controller 190 (shown in FIGS. 4-7) that is capable of executing software instructions for processing data received from the remote control device 20 (shown in FIG. 1) and for providing a main start-up menu 360. Set-top box 10, 11 includes an HDMI output 310. In some embodiments, an RCA audio/visual (A/V) output 320 may be provided. The controller 190 transmits the main start-up menu 360 via the HDMI output 310 (or RCA A/V output 320) to a display device 305.

The start-up menu 360 includes one or more applications including a channel guide application 350 (e.g., electronic program guide) for live local channel programming information. The start-up menu 360 may include: application A1 (e.g., “Media Center”) providing the user with the capability to access entertainment contents; application A2 (e.g., “Favorites”) providing a directory where the user can link frequently accessed application icons or shortcuts for quicker access; application A3 (e.g., “Internet Browser”) providing the user with the capability to surf the Internet; application A4 (e.g., “Applications”) providing lists of all applications installed in the operating system 390; application A5 (e.g., “App Store”) providing the user with a capability to browse for and install new applications; and application A6 (e.g., “Settings”) providing the user with a capability to adjust and make configuration changes to the set-top box 10, 11 settings.

Set-top box 10, 11 includes a digital television tuner 340. In some embodiments, the digital television tuner 340 may be an Advanced Television Systems Committee (ATSC) tuner, or other QAM tuner. An ATSC tuner, often called an ATSC receiver or HDTV tuner, is a type of television tuner that allows reception of digital television (DTV) channels transmitted by television stations in North America. An ATSC tuner allows for the reception of audio and video signals from over-the-air (OTA) television broadcasts. OAM (quadrature amplitude modulation) is the format by which digital cable channels are encoded and transmitted via cable television providers. In other embodiments, a DVB-T tuner or other tuner device may be utilized. The tuner 340 receives the television signals either from a cable box (e.g., via coaxial cable input 141 shown in FIGS. 5 and 7) or through an antenna system, which is described in more detail later in this description with respect to FIGS. 6 and 7.

Set-top box 10, 11 includes a wireless network interface 332 communicatively coupled to a network 303. In some configurations, items of content and/or associated information are stored on a server, which may be communicatively connected via the network 303 to the set-top box 10, 11. The content may be communicated via the network 303 as data, packets, or other types of analog and digital signals.

The network 303 may include wireless networks, data or packet networks, cable networks, satellite networks, Internet protocol television (IPTV) networks, private networks, public networks, cloud networks, or other types of communications networks. The network 303 may represent a single communication service provider or multiple communications service providers. In some embodiments, the set-top box 10, 11 communicates with the network 303 using a standard Internet protocol (IP), and may use one or more IP addresses.

Those skilled in the art will recognize that the network 303 may include one or more network devices utilized to enable, initiate, route, and manage content and other communications between one or more networks, connections, or communications devices. For example, the network 303 may include a local area network (LAN), a wide area network (WAN), a metropolitan area network (MAN), a telephone network, such as the public switched telephone network (PSTN) or a cellular network, the Internet, an intranet, an extranet, a private network, other network, or a combination of networks.

As shown in FIGS. 4 and 5, the set-top box 10 generally includes a first printed circuit board (PCB) 161 and a second PCB 162 disposed within the housing 101. In some embodiments, the first PCB 161 is communicatively coupled via a bus 130 to the second PCB 162. Bus 130 may include conductors that permit communication among the components of the first PCB 161 and the second PCB 162. In other embodiments, the circuitry of the first PCB 161 and the circuitry of second PCB 162 may be formed on a single PCB.

In the embodiment illustrated in FIG. 5, the input/output ports and connectors are located on the rear S4 of the housing 101 of the set-top box 10. A power on/off switch 91 is provided, along with a 12-volt DC power plug receptacle 93 for connecting the set-top box 10 to a power source. Set-top box 10 includes an HDMI port 175. Set-top box 10 includes a coaxial cable input 141 and a coaxial cable output 150. Connectors for audio-L 151, audio-R 152, and S-video 157 may be provided. Set-top box 10 may include an S/PDIF (Sony/Philips Digital Interface Format) port 158, e.g., to provide for connection to an external home theater audio system. Set-top box 10 may include a LAN port 147 and/or a TF card slot 173. Set-top box 10 may include one or more USB ports. In the embodiment illustrated in FIG. 5, the set-top box 10 includes a first USB port 121, a second USB port 122, and a third USB port 123.

It is to be understood that set-top box 10 may include additional, fewer, or different input/output ports and connectors than shown in FIG. 5. Those skilled in the art will recognize that the types of input/output ports and connectors and their relative locations on the housing 101 may be varied from the configuration depicted in FIG. 5.

In some embodiments, the first PCB 161 includes a computer-readable medium 192 (also referred to herein as “memory 192”), a controller 190, a wireless network interface controller 181, and a wired network interface controller 185. In some embodiments, the controller 190 is coupled to memory 192. The controller 190 may be coupled to a display device and/or other device (e.g., touchscreen, biometrics reader, etc.) associated with the housing 101. The controller 190 may be coupled to another controller, such as the wireless network interface controller 181 and/or the wired network interface controller 185.

When executed, software instructions stored in memory 192 may cause the controller 190 to perform one or more processes described herein. In some embodiments, memory 192 stores computer executable instructions which when executed by the controller 190 implements transmitting content from the HDMI port 175 to the display device 305. Additionally, or alternatively, electronic circuitry or other logic may be used in place of or in combination with software instructions to perform one or more processes described herein.

As shown in FIGS. 4 and 5, the wireless network interface controller 181 is coupled via a transmission line 114 to the antenna 12. A connector 113 may be provided between the antenna 12 and the transmission line 114. Antenna 12 may be utilized for receiving signals from a router's wireless signal antenna 402. The LAN port 147 may be used for receiving signals from a network 303 (shown in FIG. 3). With such a network interface, it is contemplated that the controller 190 may receive information from the network 303, or may output information to the network 303. It is to be understood that method embodiments of the present disclosure may execute solely upon controller 190, or may execute over the network 303 in conjunction with a remote processor that shares a portion of the processing.

The second PCB 162 includes a tuner processor 184. In some embodiments, the tuner processor 184 is coupled to the coaxial cable input 141 and/or the coaxial cable output 150. During operation of the television program and online streaming media delivery system 100, after the user has turned on a display device 303 (e.g., an HDTV television), a home screen appears with icons and/or text relating to the designated applications of the main start-up menu 360 (shown in FIG. 3). Using the remote control device 20, the user may navigate to the channel guide application 350 to view an electronic program guide for live local channel programming information.

In some embodiments, as shown for example in FIG. 5, the set-top box 10 includes a third PCB 163. The third PCB 163 may be coupled to the user input device 107 and/or the first and second visual indicator devices 103 and 105. As shown in FIG. 5, the first PCB 161 is communicatively coupled via a connector 111 to the third PCB 163. In other embodiments, the user input device 107 and/or the first and second visual indicator devices 103 and 105 may be coupled to the first PCB 161 and/or the second PCB 162.

FIGS. 6 and 7 show an online streaming media device/set-top box 11 (also referred to simply as “set-top box 11”) in accordance with an embodiment of the present disclosure. Set-top box 11 is similar to the set-top box 10 of FIGS. 1, 4 and 5, except for the antenna system and the tuner processor 182 shown in FIGS. 6 and 7. Further description of the like elements is omitted in the interests of brevity.

As shown in FIGS. 6 and 7, the set-top box 11 includes a tuner processor 182 and an antenna 17. In some embodiments, the tuner processor 182 is a wireless chipset and hybrid tuner processor that acts as either an analog or digital tuner. In some embodiments, as shown for example in FIGS. 6 and 7, the tuner processor 182 is located on the second PCB 162. The tuner processor 182 is coupled via a transmission line 119 to the antenna 17. A connector 118 may be provided between the antenna 17 and the transmission line 119. Antenna 17 may be utilized for receiving OTA broadcast delivery signals.

In some embodiments, OTA digital broadcast signals received via a remote antenna 602 are transmitted via a wireless transmitter 606 associated with the remote antenna 602 and received by the antenna 17. In some embodiments, the wireless transmitter 606 utilizes wireless 802.11 (B,G,N or AC) PHY for wireless communication using a single or combination of 900 MHz and 2.4, 3.6, 5, and 60 GHz frequency bands to transmit Wi-Fi signals to the antenna 17.

In some embodiments, the antenna 17 utilizes wireless 802.11 (B,G,N or AC) PHY for wireless communication using a single or combination of 900 MHz and 2.4, 3.6, 5, and 60 GHz frequency bands to receive Wi-Fi signals transmitted from an antenna 607 of the wireless transmitter 606. During operation of the set-top box 11, data received via the antenna 17 is communicated to the tuner processor 182, which outputs the processed signals to the operating system 390, for potential transmission to the display device 305.

It is to be understood that features of the presently-disclosed set-top box embodiments may be combined in a variety of configurations. It is to be understood that set-top box embodiments in accordance with the present disclosure may include additional, fewer, or different components than shown in the drawings. Furthermore, embodiments of at least portions of the presently-disclosed set-top box can take the form of a computer program product accessible from a computer-readable medium providing computer executable instructions, or program code, for use by or in connection with a computer or any instruction execution system.

It will be apparent to those of ordinary skill in the art that aspects of set-top box embodiments, as described above, may be implemented in various forms of hardware, software, firmware, special purpose processors, or a combination thereof. Thus, the operation and behavior of the aspects were described without reference to the specific software code—it being understood that a person of ordinary skill in the art would be able to design software and control hardware to implement the aspects based on the description herein.

Although embodiments have been described in detail with reference to the accompanying drawings for the purpose of illustration and description, it is to be understood that the disclosed processes are not to be construed as limited thereby. It will be apparent to those of ordinary skill in the art that various modifications to the foregoing embodiments may be made without departing from the scope of the disclosure. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A set-top box for controlling a display device, the set-top box comprising:
a controller;
a first circuitry for receiving over-the-air broadcast digital content;
a second circuitry for receiving online streaming content over IP protocol;
an operating system running on the controller,
wherein the operating system is configured to allow a user to selectively switch between on-line content and local over-the-air broadcast programs without shutting down the set-top box.

2. The set-top box of claim 1, further comprising a first antenna for receiving over-the-air digital broadcast signals.

3. The set-top box of claim 2, wherein the first circuitry includes a wireless network interface controller communicatively coupled to the first antenna.

4. The set-top box of claim 1, further comprising a second antenna for receiving online streaming content.

5. The set-top box of claim 4, wherein the second circuitry includes a tuner processor communicatively coupled to the second antenna.

6. The set-top box of claim 1, wherein the controller is configured to transmits a main start-up menu to a display device.

7. The set-top box of claim 6, wherein the main start-up menu includes one or more applications including a channel guide application.

8. The set-top box of claim 1, further comprising a coaxial cable input and a coaxial cable output.

9. The set-top box of claim 8, further comprising a tuner processor communicatively coupled to either or both of the coaxial cable input and the coaxial cable output.

10. The set-top box of claim 1, wherein the over-the-air broadcast digital content is uncompressed digital high-definition television content.

11. A method of distributing content to a display device, the method comprising:
receiving by a set-top box, over-the-air broadcast television content via a first antenna;
receiving by the set-top box, online streaming content over IP protocol via a second antenna;
partitioning a display area of a display device into a first region and a second region; and
displaying television content in the first region while simultaneously displaying online streaming content in the second region.

12. The method of claim 11, further comprising transmitting the over-the-air broadcast television content received via the first antenna to a wireless network interface controller communicatively coupled to the first antenna.

13. The method of claim 11, further comprising transmitting the online streaming content over IP protocol received via the second antenna to a tuner processor communicatively coupled to the second antenna.

14. The method of claim 11, wherein the first antenna receives the over-the-air broadcast television content via a remote transmitter associated with a remote antenna.
